(19) United States
(12) Patent Application Publication
(10) Pub. No.: US 2021/0230933 A1
(43) Pub. Date: Jul. 29, 2021

(54) EXTERIOR VENTED GLAZING SYSTEMS AND METHODS OF GLAZING

(71) Applicant: MICHAEL ROSS HODGES, DUNEDIN (NZ)

(72) Inventor: MICHAEL ROSS HODGES, DUNEDIN (NZ)

(21) Appl. No.: 15/734,515

(22) PCT Filed: Jun. 5, 2019
(86) PCT No.: PCT/NZ19/50065

§ 371 Date: Dec. 2, 2020

(30) Foreign Application Priority Data
Jun. 5, 2018 (NZ) 743131

(51) Int. Cl. E06B 7/10; E06B 3/22; E06B 3/10; E06B 3/24; E06B 3/64; E06B 3/66; E06B 7/12

(52) U.S. Cl. CPC E06B 7/10; E06B 3/22; E06B 3/10; E06B 2007/026; E06B 3/64; E06B 3/66; E06B 7/12; E06B 3/24

(57) ABSTRACT

This present invention generally relates to the manufacture and application of a vented glazing system to existing glazed units or new glazing units. More particularly this invention relates to a method of glazing and a glazing system that will increase thermal performance and reduce condensation for existing glazed units.

### TECHNICAL FIELD

This present invention generally relates to the manufacture and application of secondary glazing to existing windows. More particularly this invention relates to a method of glazing and a glazing system that will increase thermal performance and reduce condensation for existing windows.

### BACKGROUND

Double glazing has become a requirement for new buildings in many countries. Double glazing the term used to describe windows that are fitted into a window cavity that have two layers of glass with a space or gap in between. The main reason double glazing is used is to provide increased insulation protection from temperature extremes in both hot and cold climates. Secondary glazing involves installing supplementary glazing on the inside of an existing single glazed window. Secondary glazing is also used on older homes that only have single glazed windows. Double Glazing and secondary glazing both have their advantages and disadvantages. Double glazing is attractive but has a short life cycle of between 12-25 years before the seal fails which leads to inefficiency or internal fogging. Secondary glazing is cheaper but less aesthetically attractive and can suffer from internal fogging due to the glazing being not fully sealed.

The reason why traditional secondary and double-glazing units fail is because they are exposed to thermal pumping from heat expansion followed by cool contraction. In the passage of time the perimeter seal fails and allows moist air or water vapour to be suctioned inside the unit which builds up and eventually destroys the window's efficiency and visibility. Some double glazing units have a desiccating agent within them that absorbs moisture or water vapour that may already be trapped or has leaked in, but this has a limited capacity after which the desiccant can no longer hold moisture and becomes condensation within the window cavity.

Secondary glazing has no ability to regulate air movement and can also suffer from absorbing moisture that builds up and forms condensation within the cavity, causing reduced visibility and moisture damage.

It is therefore an object of the present invention to overcome some of these known difficulties with glazing systems or to at least provide the public with a useful alternative.

### SUMMARY OF THE INVENTION

This present invention relates to a glazing system and a glazing method that controls the air within a secondary glazing panel or multi glazing panel by way of one or more vents that permit minimal air movement so to minimise the thermal pumping stress on a window.

In one aspect of the present invention, there is provided a glazing system comprising:
(i) a glazing frame;
(ii) at least one glazing panel set within the glazing frame so that the glazing frame surrounds the periphery of the glazing panel; and
(iii) the glazing frame further including at least one vent assembly positioned proximate the upper periphery of the glazing panel and at least one vent assembly positioned proximate the lower periphery of the glazing panel, the glazing frame and the glazing panel being configured to be attached to the external framework of an existing glazed unit to thereby provide a vented cavity between the glazing panel and the existing glazed unit, the at least one upper vent assembly providing a channel for air to move from the cavity between the glazing panel and the existing glazed unit to the exterior of the glazing system, and the at least one lower vented assembly providing a channel for air to move from the exterior of the glazing system into the interior space between the glazing panel and the existing glazed unit.

In one aspect of the present invention, there is provided a glazing system comprising:
(i) a glazing frame;
(ii) at least two spaced apart glazing panels set within the glazing frame so that the glazing frame surrounds the periphery of the glazing panels; and
(iii) the glazing frame further including at least one vent assembly positioned proximate the upper periphery of the glazing panel and at least one vent assembly positioned proximate the lower periphery of the glazing panels to provide a vented cavity between the glazing panels, the at least one upper vent assembly providing a channel for air to move from the cavity between the glazing panels to the exterior of the glazing system, and the at least one lower vented assembly providing a channel for air to move from the exterior of the glazing system into the cavity between the glazing panels.

In one aspect of the present invention there is provided a vented corner component suitable for use in constructing a glazing system as defined herein the vented corner component being configured to secure two glazing frame panels, in use, each panel extending from the vented corner component in a substantially orthogonal direction to the other panel, the vented corner component further configured to provide one or more channels that in use allow air to flow from the interior of the glazing system to exterior of the glazing system.

In another aspect, the present invention provides a vented multipaneled glazing unit comprising at least two spaced apart glazing panels, a peripheral frame securing the glazing panels at a distance from one another and enclosing a cavity between the glazing panels, the peripheral framework including at least one upper vented assembly that provides a channel for air to move from between the spaced apart glazing panels to the exterior of the glazing unit, and the peripheral framework including at least one lower vented assembly that provides a channel for air to move from the exterior of the glazing unit into the interior space between the spaced apart glazing panels.

In one embodiment the vent assemblies of the glazing units or glazing systems of the present invention may contain clay, desiccating agents or metal balls whose purpose is to attract moisture or water vapour from inflowing cool air as the window expands and sucks air into the expanding cavity. Once the window begins to cool down it will contract and expel warm dry air back through the vents. The drier air will reabsorb the moisture or water vapour captured in the desiccating agent, clay or on the metal balls and expel the moisture back out through the vents. This invention minimizes external ingress of moisture and expels water vapour that may cause condensation to form between the panels in the application of secondary glazing.

### BRIEF DESCRIPTION OF THE DRAWINGS

These and other features and of the invention will be clearly understood from the following description of an embodiment and several modifications thereof, given by way of example with reference to the accompanying drawings, in which:

FIG. 1 is a perspective view of a glazing system of the present invention in relation to an existing single glazing window, according to one embodiment.

FIG. 2 is a cross-section side view of a glazing system of the present invention in relation to an existing single glazing window, according to one embodiment.

FIG. 3 is a cross-section side view of a glazing system of the present invention in relation to internal and external moisture sources, according to another embodiment.

FIG. 4 is a section plan view of a glazing system of the present invention in relation to the process of thermal pumping, according to one embodiment.

FIG. 5 is a plan view of the bottom of the corner vent components of a glazing system.

FIG. 6 is a side perspective view of a top view of a corner vent component.

FIG. 7 is a plan view of the bottom of a corner vent component.

FIG. 8 is a perspective view of the main frame components required for a glazing system, according to one embodiment.

FIG. 9 is a perspective schematic view of the assembly of the frame components shown in FIG. 8 into a glazing system.

FIG. 10 is a perspective schematic view of the present invention in relation to the application of air sealing components for a glazing system as shown in FIG. 9.

FIG. 11 is a perspective schematic view of the present invention in relation to the application of water seal components for a glazing system as shown in FIG. 10.

FIG. 12 is a perspective view of a glazing system of the present invention in relation to its application to an existing single glazed window, according to another embodiment.

FIG. 13 is a perspective schematic view of the glazing system shown in FIG. 12 in relation to its fixing to an existing single glazed window.

FIG. 14 is a perspective schematic view of the glazing system shown in FIG. 13 in relation to its sealing to an existing single glazed window.

FIG. 15 is a perspective view with a cut away section of a glazing system of the present invention in relation to it being constructed as a timber framed, secondary glazing unit according to another embodiment.

FIG. 16 is a perspective view with a cut away section of a glazing system of the present invention in relation to it being constructed as a PVC u framed, secondary glazing unit according to another embodiment.

FIG. 17 is a perspective view with a cut away section of a glazing system of the present invention in relation to it being constructed as a PVC u framed, tertiary glazing unit according to another embodiment.

FIG. 18 is a cross-section view of the glazing system as shown in FIG. 17 affixed to an existing single glazed unit.

FIG. 19 is an exploded section view of the components of the glazing system shown in FIG. 18.

FIG. 20 is a perspective view of the corner vent components of a glazing system as shown in FIGS. 16 to 19, with one component showing a partial cutaway to reveal that the component houses a desiccant.

FIG. 21 is a perspective view of the lower section of the glazing unit as shown in FIGS. 16 to 20 showing the airflow within the lower section of the unit.

FIG. 22 is a perspective view of the upper section of the glazing unit as shown in FIGS. 16 to 20 showing the airflow within the upper section of the unit.

FIG. 23 is a perspective cross-sectional view of a double-glazing unit of another embodiment of the present invention.

FIG. 24 is a cross-sectional view of the double-glazing unit shown in FIG. 23.

FIG. 25 is an exploded section view of the double-glazing unit shown in FIG. 24.

FIG. 26 is a perspective cross-sectional view of a triple-glazing unit of another embodiment of the present invention.

FIG. 27 is a perspective view with a cut away section of a glazing system of the present invention in relation to it being constructed as a PVC u framed, secondary glazing unit according to another embodiment.

FIG. 28 is a perspective view with a cut away section of a glazing system of the present invention in relation to it being constructed as a PVC u framed, tertiary glazing unit according to another embodiment.

FIG. 29 is a perspective view of the glazing system as shown in FIG. 28 affixed to an existing single glazed unit.

FIG. 30 is a cross section view of the components of the glazing system shown in FIG. 29.

FIG. 31 is an exploded view of the components of the glazing unit as shown in FIGS. 27 to 30.

### DEFINITIONS

The term “glazed unit” as used herein means a window or a door that includes a glass or see-through panel.

The term “desiccant” as used herein means a desiccating agent that has an ability to release moisture as low as 50 degrees Celsius. The internal heating of the sun on a multi-glazed unit can increase temperatures well above 50 degrees Celsius which provides suitable conditions for a desiccant to release moisture and to dry allowing for many desiccant cycles to be achieved. A suitable low temperature moisture release desiccant is a clay material, such as a bentonite clay. A desiccant would be unsuitable and specifically excluded from the scope of this invention if it required a much higher temperature, over 100 degrees Celsius, to release any moisture retained.

### DETAILED DESCRIPTION

In the following detailed description, reference is made to the accompanying drawings, which form a part hereof, and in which are shown by way of illustration specific embodiments in which the invention may be practiced. It is to be understood that other embodiments may be utilised, and structural changes may be made without departing from the scope of the present invention.

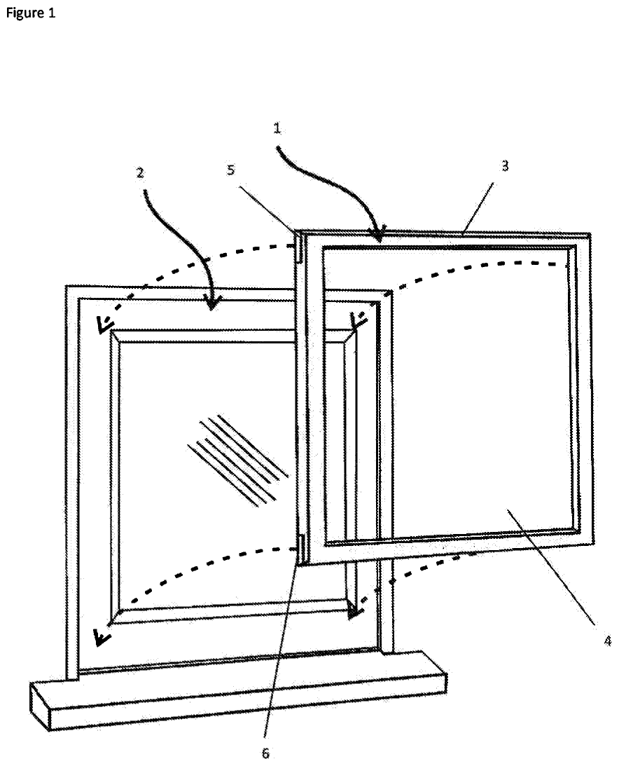

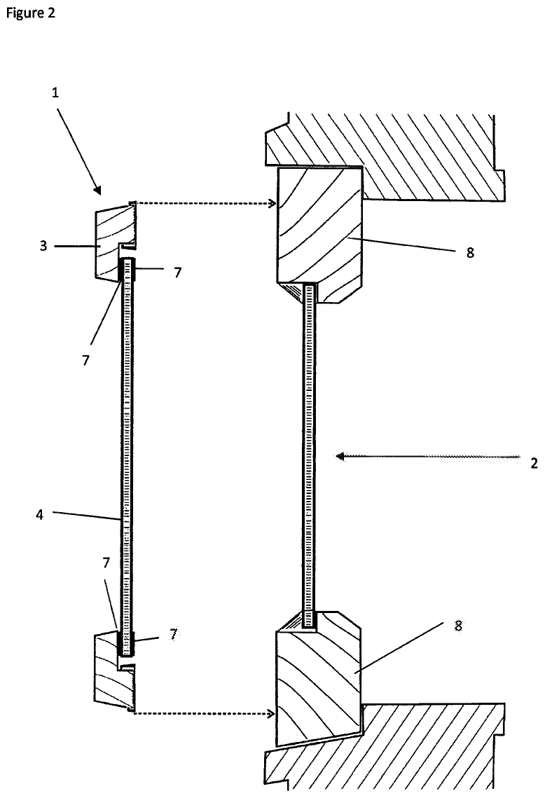

With reference to FIG. 1, a front perspective view of a glazing system 1 of one embodiment of the present invention is being applied to an existing single glazing window 2. The glazing system 1 comprises an external frame 3, that completely surrounds the edges of a glazing panel 4. An upper vented corner component 5 is shown in the upper left corner and a lower vented corner component 6 is shown in the lower left corner. A cross-section view of the embodiment shown in FIG. 1 is shown in FIG. 2.

The secondary glazing panel 1 in this embodiment comprises a wooden frame 3 that is rebated to fit a panel of glass or plastic 4. The components of the wooden frame 3 are joined at the corners by upper vented corner components 5 and lower vented corner components 6 that serve to hold the frame components together as well as perform the function of venting the cavity between the existing window 2 and the secondary glazing panel 4. In this instance, the glazing panel 4 is secured to the wooden frame components 3 waterproof tapes 7, however, it is to be appreciated that other securement means could be employed, such as other adhesive means or mechanical means such as secured by fitted rubber seals, silicon adhesive, mechanical clips or the like.

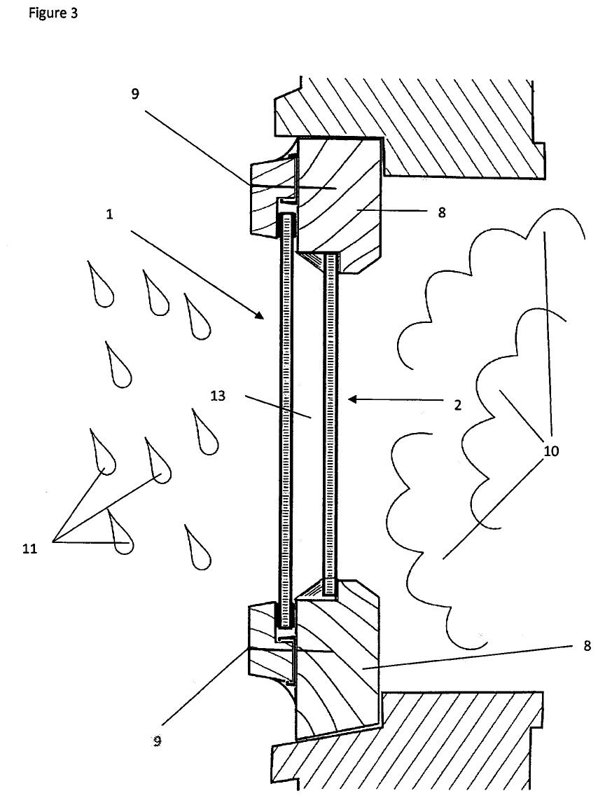

As shown in FIGS. 2 and 3, the secondary glazing unit 1 is fastened onto the broad faces of the existing window sash 8. FIG. 3 is a section view of glazing unit shown in FIGS. 1 and 2 fixed to the existing window using nails, pins or screws 9. FIG. 3 also shows the glazing unit 1 and existing window 2 in relation to the internal water vapour/moisture source 10 and the external moisture source 11 to which the glazing unit and existing window are exposed. In addition an edge sealant 12 may be applied around the perimeter of the secondary glazing unit 1 to prevent external moisture 11 entering into the vented cavity 13 between the secondary glazing unit 1 and the window 2. Internal moisture or water vapour 10 is prevented from escaping into the vented cavity 13 by sealing 14 around the inside of the window.

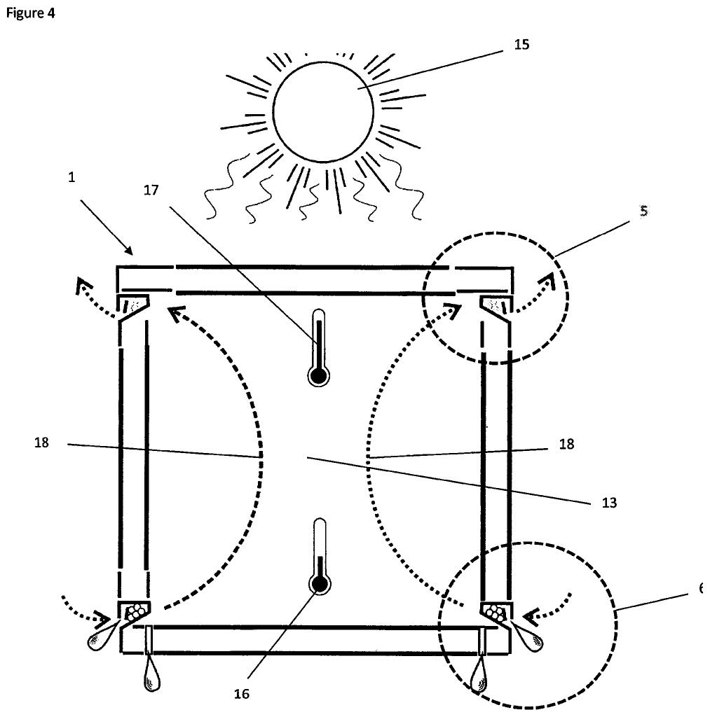

With reference to FIG. 4, a sectional plan view of the glazing unit 1 shows schematically the process of thermal pumping that occurs when the glazing unit is exposed to high and low temperatures. Thermal pumping is the process that occurs when the sun 15 heats the glass 4 and causes the glass to expand. This process pulls air into the vented cavity 13 through the lower/bottom external vents 6. The air within cavity 13 rises from the cooler or lower area 16 to the warmer or upper area 17 producing a cycle of air movement represented by arrows 18. Warm air absorbs any water vapours from within the vented cavity 13 and expels it out through the upper/top external vents 5. Any water vapour that condenses inside the vented cavity 13 can drain out the lower/bottom vent/drain 6

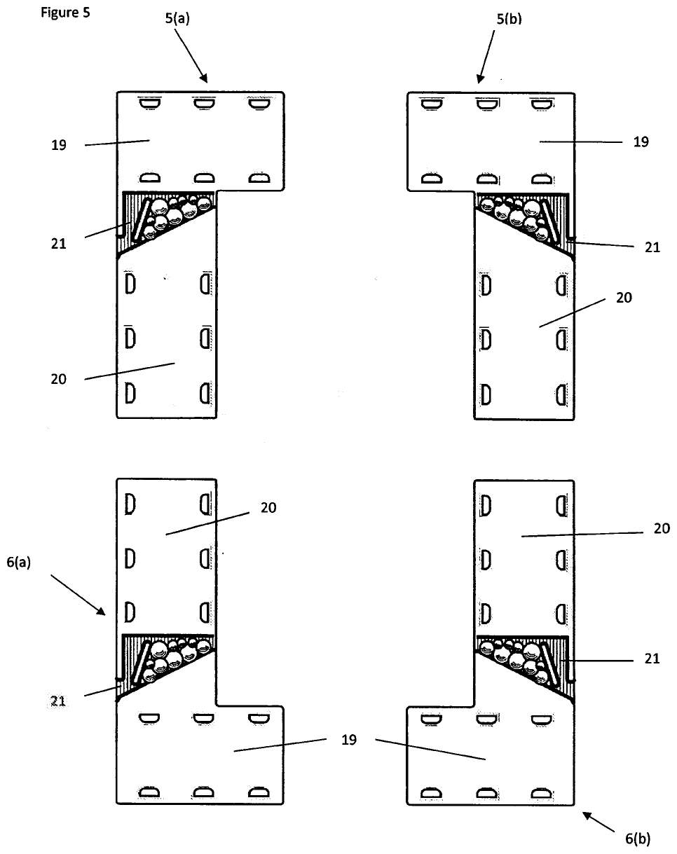

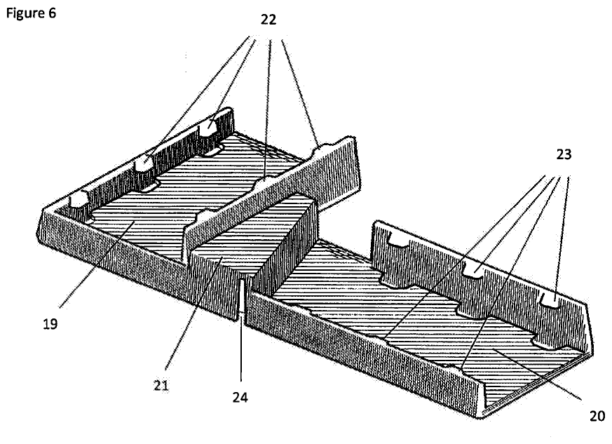

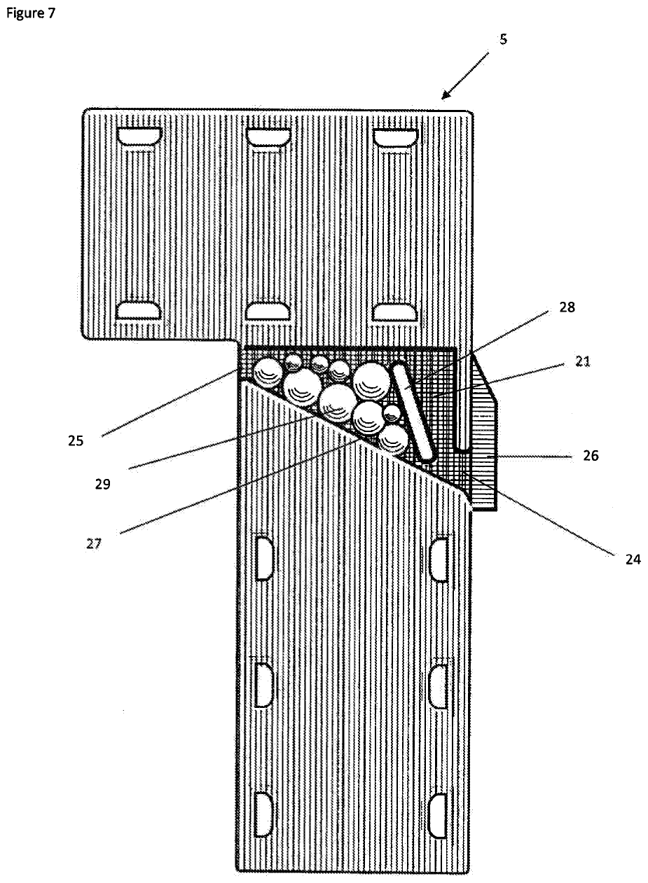

With reference to FIG. 5 showing a plan view of the upper and lower vented corner components used in a glazing unit of one embodiment of the invention. It is to be appreciated that each vented corner component is specific to each corner. The upper vented corner components form a pair of vents 5a and 5b each reflecting a mirror image of the other and the bottom vented corner components 6a and 6b also form a pair of vents each reflecting a mirror image of the other. Each vented corner component comprises three sections. The first section 19 is adapted to receive a horizontal frame panel (not shown). The second section 20 is adapted to receive a vertical frame panel. The third section 21 is the vent chamber. The profile details of a vented corner component is shown in FIGS. 6 and 7. The vented corner components are constructed from a plastics or polymeric material that can be readily injected molded.

With reference to FIG. 6, the top face of the vented corner component 5 has a first section 19 adapted to provide a horizontal slot for a horizontally extending section of wooden frame. This first section 19 includes a plurality of teeth 22 that engage with and secure each edge of the horizontally extending section of the wooden frame. The second section 20 is adapted to provide a vertical slot for a vertically extending section of wooden frame. The second section 20 also includes a plurality of teeth 23 that in use engage with and secure each edge of the vertically extending section of the wooden frame.=The vent chamber 21 is covered from the top to prevent external moisture access. The air flow is controlled through slots 24 from the outside and slot 25 on the inside. The external vent slot 24 is shielded by flange 26 to prevent sealant from blocking the slot 24 and to direct surface water away from the vent slot 24.

FIG. 7 shows a plan view of the bottom of a vented corner component 5 in relation to the vent chamber's 21 internal components.

The vent chamber 21 has a sloping base 27 to drain water and to stop the ingress of external water. The vent chamber 21 has a non uniform shape and baffles 28 to prevent water suction. The vent chamber 21 can optionally house a desiccating agent, a clay or metal pallets 29 that serve to absorb any moisture being carried by the external air before it flows into any glazing cavity. The desiccating agents also serve to prevent insects from infesting the vent chamber 21 or entering into any glazing cavity. In use, a layer of tape or a cap is positioned over the vent chamber to retain the desiccating agent in situ before installation.

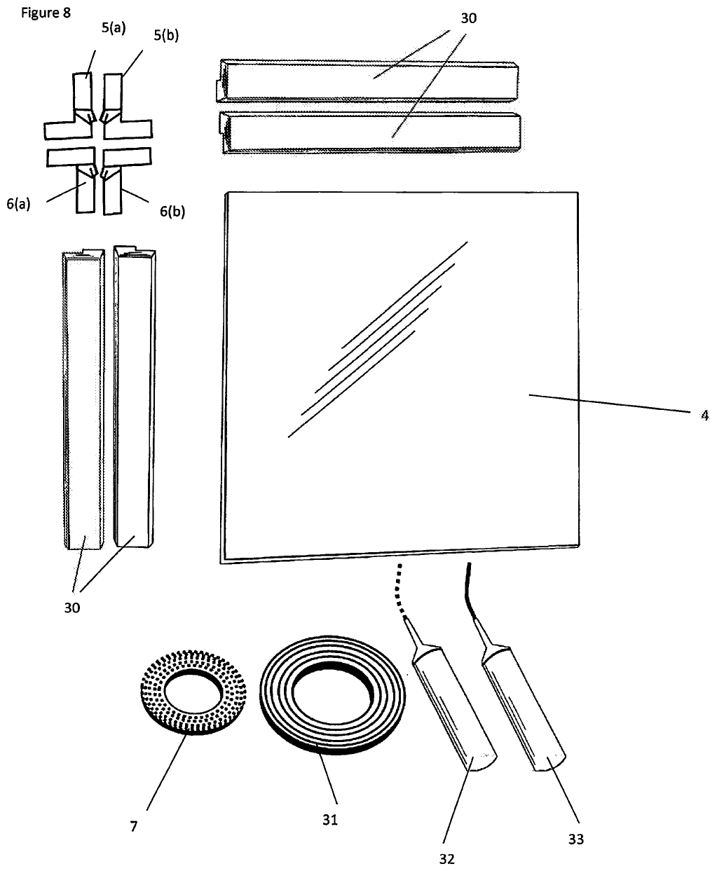

In assembling a glazing unit of the present invention a number of components are required and these are illustrated schematically in FIG. 8. The main components comprise four vented corner components 5a, 5b, 6a, 6b, wooden frame sections 30, glass or plastic glazing panel 4, adhesive tape 7, foam tape 31, clear sealant 32, and paintable sealant 33.

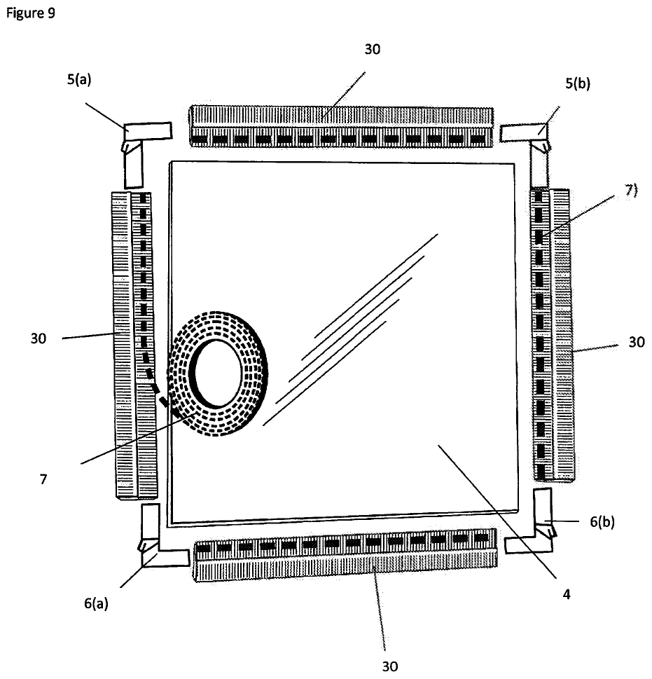

The assembly of the components to form a glazing unit of the present invention is shown schematically in FIGS. 9, 10 and 11. The assembly of a secondary glazing unit 1 requires the wooden frame sections 30 to be clipped together using the vented corner components 5a, 5b, 6a and 6b. The adhesive tape 7 is applied into the cavity of the wooden frame sections 30 as shown in FIG. 9. The glassing panel 4 can be positioned and fixed to the adhesive tape 7.

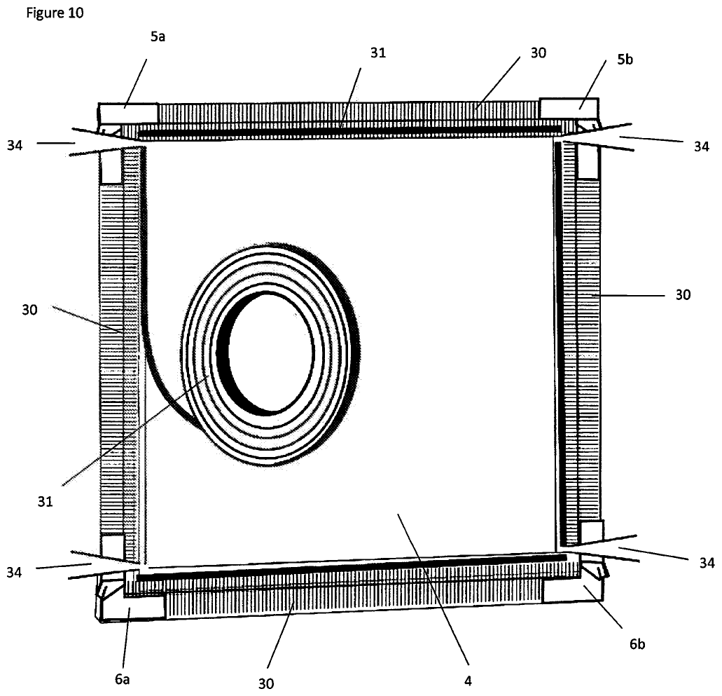

FIG. 10 is a perspective view showing the application of air seal components. The air seal foam tape 31 can be fixed to the cavity side of the glazing panel 4. The air seal foam tape 31 must be applied to ensure small gaps 34 are left adjacent to the slots 24 of the external vents

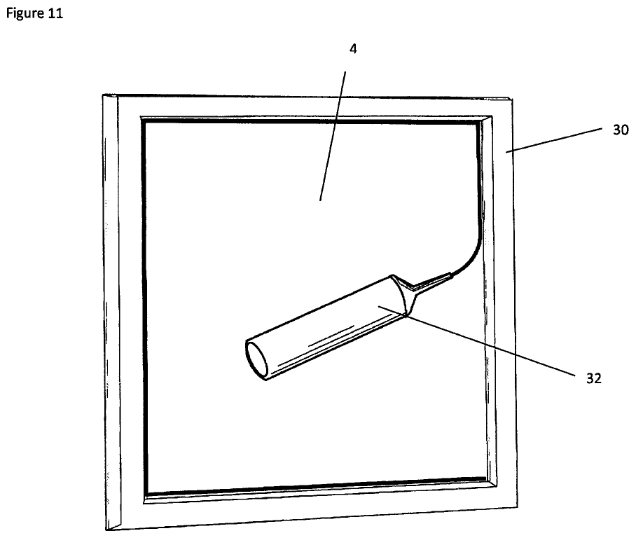

FIG. 11 is a perspective view showing the application of water seal components. The water seal 32 is applied around the parameter of the glazing panel 4 and the wooden frame 3.

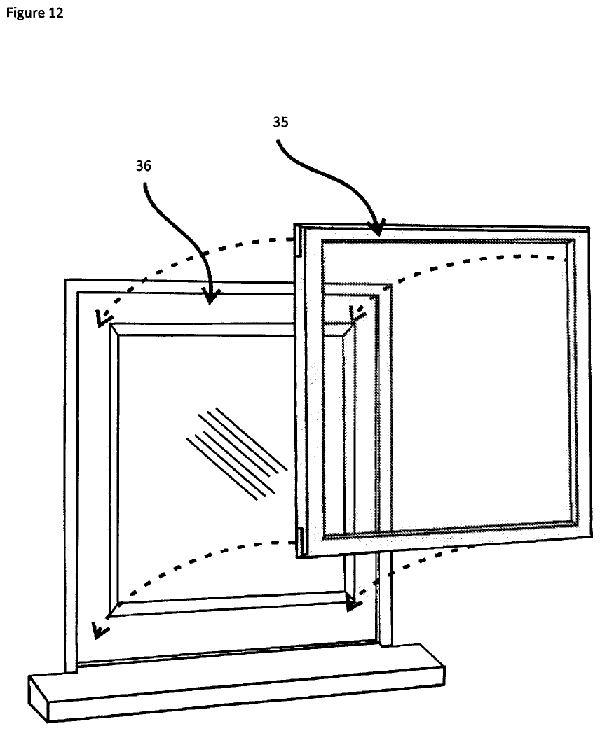

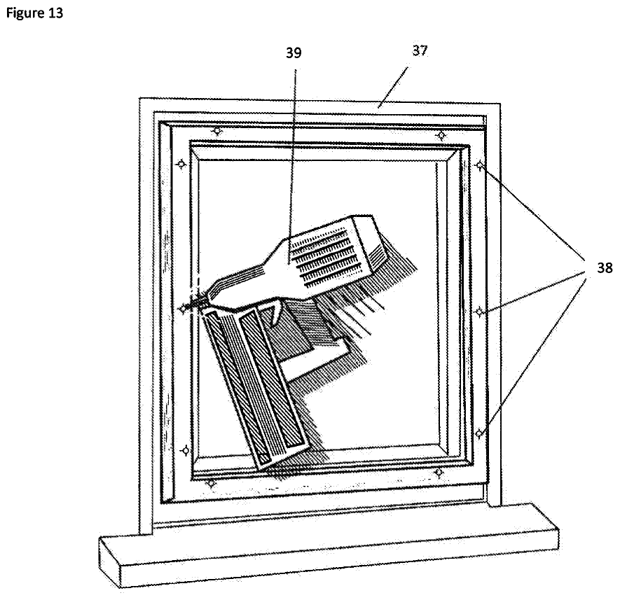

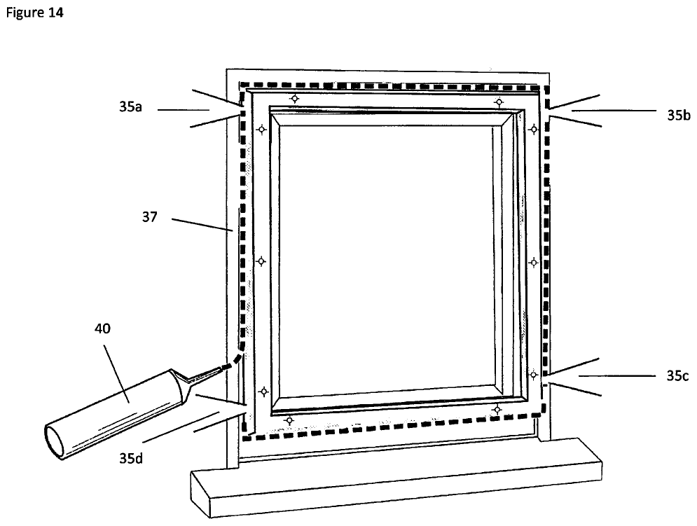

With reference to FIG. 12, a perspective view is shown of a glazing unit 35 of one embodiment of the present invention being positioned onto the face of to an existing single glazed window 36. As shown in FIG. 13, the glazing unit 35 is fixed to the framework 37 of an existing single glazed window, the fixings 38 being determined based on the nature of the framing 37 of the glazing unit and the framework of the existing window. In the embodiment illustrated a nail gun 39 is used to fix the wooden framed single glazing unit 35 to the wooden framework 37 of the existing window. With reference to FIG. 14, which shows a perspective view of a sealing agent 40 being applied to the joint between the wooden frame 37 of the existing window and the frame of the glazing unit 35, with care being taken to leave access to the openings of the external slots of vents 5a, 5b, 5c, 5d

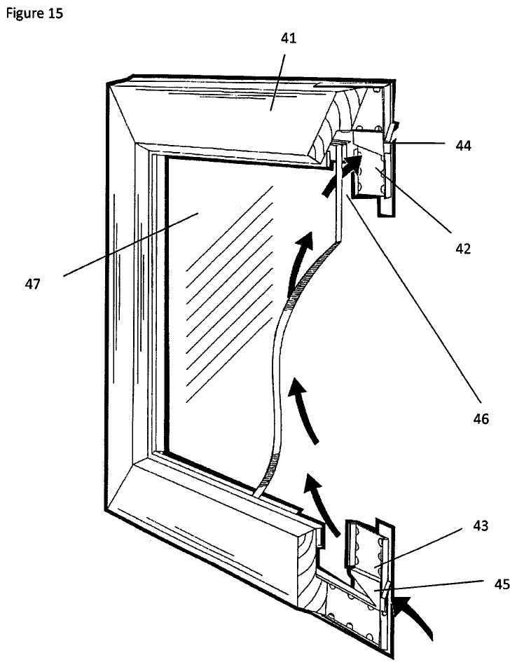

FIG. 15 is a perspective view with a cut away section of another embodiment of a glazing unit 41 according to the present invention. This embodiment of a glazing unit is a timber framed, secondary glazing unit. The cut away section in FIG. 15 reveals the corner vented components 42 and 43 that support the construction of the timber frame 41 from timber panels as well as provide the vent chambers 44 and 45 respectively. FIG. 15 also shows schematically the air flow pathway with air entering in through the lower vent 45 and progressing up through the cavity 46 (the space between the glass panel 47 and the glass panel of an existing window (not shown). The thermal pumping process of the sun, or heat from the home, heating the air within the cavity 46 when the glazing unit is installed and in use, moves the air out through the top vent 44. The heating air will carry with any water vapour that rises as a result of the temperature increase experienced within the cavity 46.

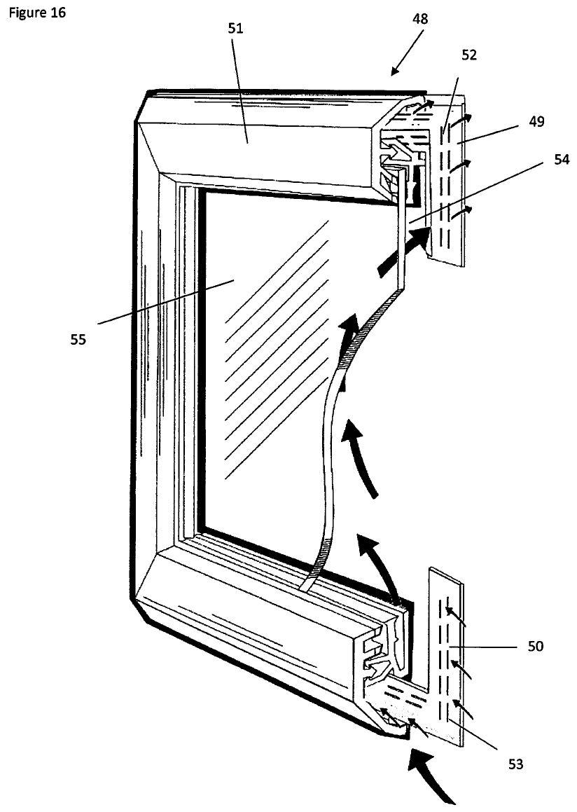

FIG. 16 shows a perspective view of another embodiment of a glazing unit 48 with a cut away section of the present invention. This embodiment of glazing unit 48 is unplasticised polyvinyl chloride (PVC u) framed. It is to be appreciated that other polymeric materials may be suitable for producing the covers or framing for the glazing unit The cut away section reveals corner vents components 49 and 50 that support the construction of the PVCu frame 51 as well as provide the vent chambers 52 and 53. FIG. 16 shows the air flow pathway entering in through the bottom vent 53 and progressing up through the cavity 54 (the space between the glass panel 55 and the glass panel of an existing window (not shown). The thermal pumping process of the sun, or heat from the home, heating the air within the cavity 54, when the glazing unit is installed and in use, moves the air out through the upper vent 52. The heating air will carry with it any water vapour that rises as a result of the temperature increase experienced within the cavity 54.

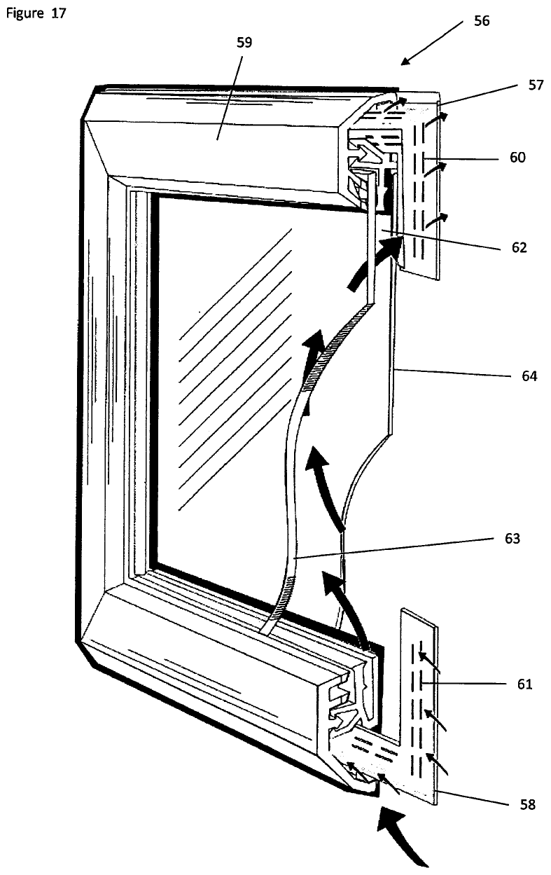

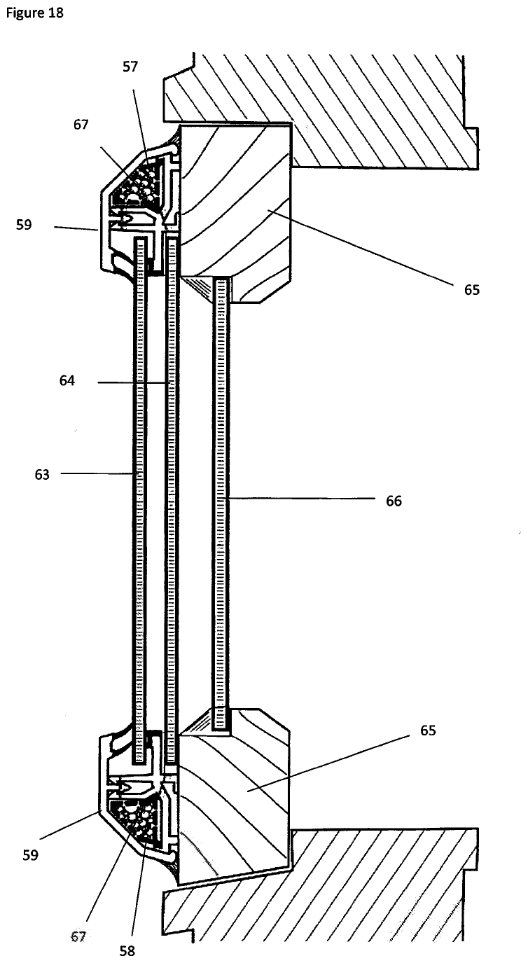

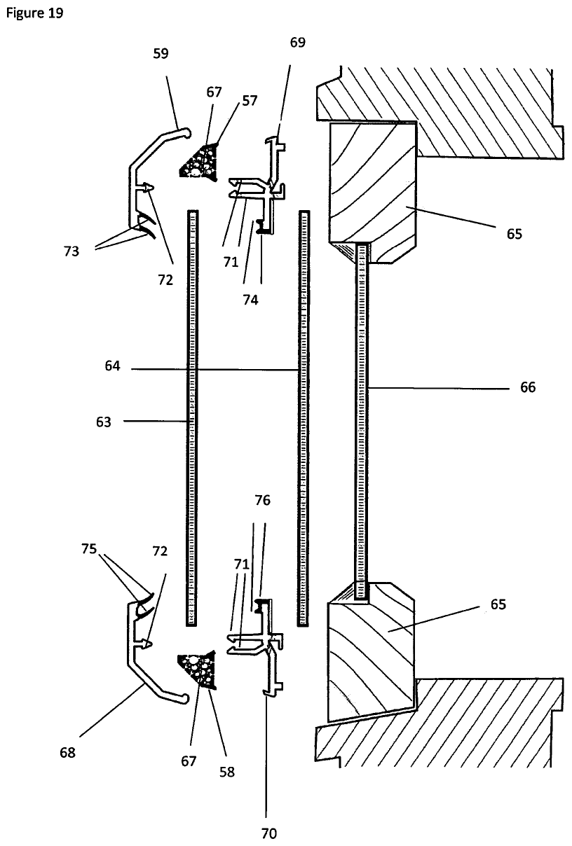

FIG. 17 is a perspective view with a cut away section of another embodiment of a glazing unit 56 of the present invention constructed as a PVCu framed, double glazing unit. This embodiment can also be used to provide a tertiary glazing system if it is applied to an existing single glazed window. Such a tertiary glazing system is best illustrated in FIG. 18. The glazing systems described in FIGS. 16-19 are attached to an existing window frame by using a pin gun to fix an 18 gauge pin through the base profile 69 (see FIG. 19).

The cut away section reveals the corner vent components 57 and 58 that support the construction of the PVCu frame 59 as well as provide the vent chambers 60 and 61. FIG. 17 shows the air pathway entering in through the lower vent 61 and progressing up through the cavity 62 between the two glass panels 63 and 64 of the glazing unit. It is to be appreciated that material used for each glazing panel in this embodiment may vary between the panels. For example, one panel may be made from glass and the other panel from an acrylic glass (eg Plexiglas™) or the like. The thermal pumping process of the sun, or heat from the home, heating the air within the cavity 62, when the glazing unit is installed and in use, moves the air out through the upper vent 60. The heating air will carry with any water vapour that rises with the temperature increase experienced within the cavity 62.

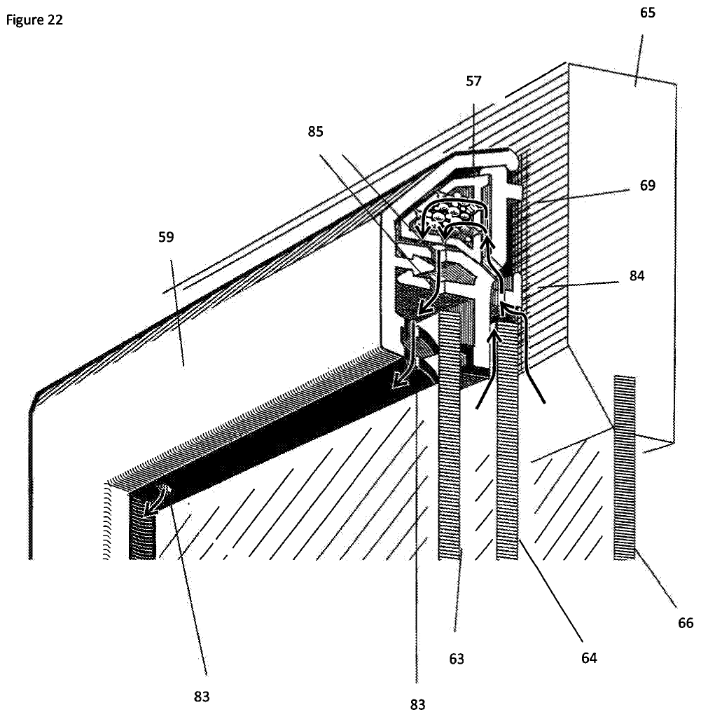

FIG. 18 is a cross-sectional view of the glazing unit embodiment shown in FIG. 17, attached to an existing window 66. This embodiment shows the existing glass panel 66 and the new glazing panels 63 and 64. This section view shows the key components including the upper and lower vent components 57 and 58, each including a clay desiccating agent 67 within the vent chambers 60 and 61 respectively. As any water vapour flows through the vent chambers, the clay will absorb the moisture from the air in the colder times and release water vapour in the warmer times. The heating and cooling is achieved through external events such as sunshine or home heating, and its counterpart of cooling over night. The intermediate glazing panel 63 may be made from an acrylic glass (eg Plexiglas™) or other such glazing panel. The glazing panel 63 directs any internal water vapour escaping between the existing window panel 66 and the glazing panel 63 upwardly toward the vent system at the top of the glazing panels, which prevents the moisture meeting and condensing on the cold external glass panel 63. This flow of air from between glazing panels 63 and 66 through the upper vent chamber 57 is schematically shown in FIG. 22.

FIG. 19 is an exploded section view of the glazing unit shown in FIGS. 17 and 18.

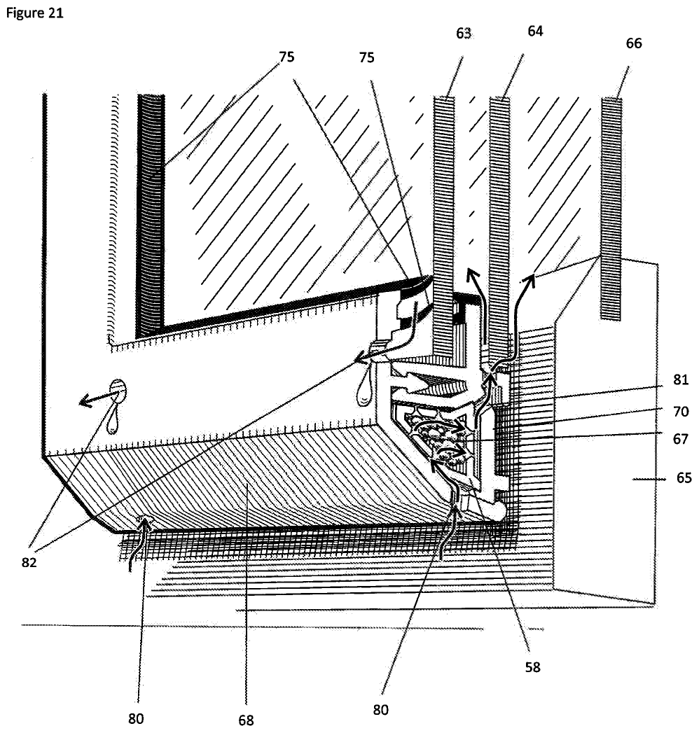

The exploded section view of the PVCu cover or outer frame profiles 59 and 68 (both shown in FIGS. 17 and 18 as frame cover 59) in relation to the existing window 66 are shown. This embodiment shows the existing glass panel 66 and the glazing panels 63 and 64. The section view shows the key components including the vented corner components 57 and 58 and a clay desiccating agent 67 in the vent chambers 57 and 58. The base profiles 69 and 70 of the PVCu frame are mounted against the existing window frame 65. The glazing panel 64 is seated on the base profile 70. The vented corner component 58 is fitted within the PVCu base profiles 68 and 70 at each lower corner. The vented corner component 57 is fitted within the PVCu cover profiles 67 and 69 at each upper corner. The surface glazing panel 63 is mounted between the base profile 68 and 70 with sealing ribs 75 and 76, the seals designed to prevent external air or moisture penetration. The cover profiles 59 and 68 are mounted on the external surface using the complementary interlocking connection means 71 and 72 that are provided on the PVCu profiles 68 and 70. The interconnected profiles are best shown in cross section in FIG. 18 and in perspective in FIGS. 21 and 22. It can be seen that the profiles of the PVCu members are further adapted to provide sealing ribs (73, 74 and 75, 76) that seal along the glazing panel 63 to keep moisture from entering the profiles. These sealing ribs are co-extruded with the rest of the PVCu profiles, and the sealing ribs are extruded from a more rubbery polymeric material than PVCu such as PVC.

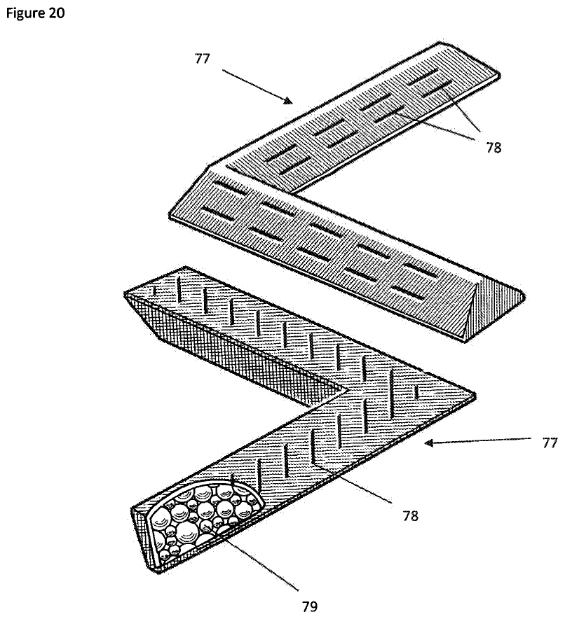

FIG. 20 is a perspective view of the present invention in relation to a corner vented component of the invention to fit a PVC u frame, according to another embodiment. A vented corner component 77 features thin slots 78 on both its upper and lower surfaces that allow air to circulate through the vent chamber 77 past the internal desiccating agent 79.

With reference to FIGS. 21 and 22, the air flow pathways (shown by arrows) that occur in the lower and upper sections of the glazing units are shown schematically for the embodiment of the glazing unit illustrated in FIGS. 18 and 19. With reference to FIG. 21, the PCVu base cover 68 includes one or more air movement orifices 80 that allow external air to move into and through the vent chamber 58 containing desiccant 67, which vapour is then free to migrate through an orifice 81 in profile 70 and up and around the glazing panel 64. The base cover 68 also provides drain orifices 82 to allow any external moisture that gets between the sealing ribs 75 and the glazing panel 63 to be conveyed out of the glazing unit.

With reference to FIG. 22, the PCVu top cover profile 59 includes one or more air movement orifices 83 that allow internal air from within the cavities to rise between glazing panels 63, 64 and 66 and to migrate out of the glazing unit after having passed through vent chamber 57 and through an orifice 84 in profile 69 to move into and through the vent chamber 58 containing desiccant 67, which vapour is then free to migrate through an orifice 85 in profile 69 and finally out through orifice 83 in profile 59.

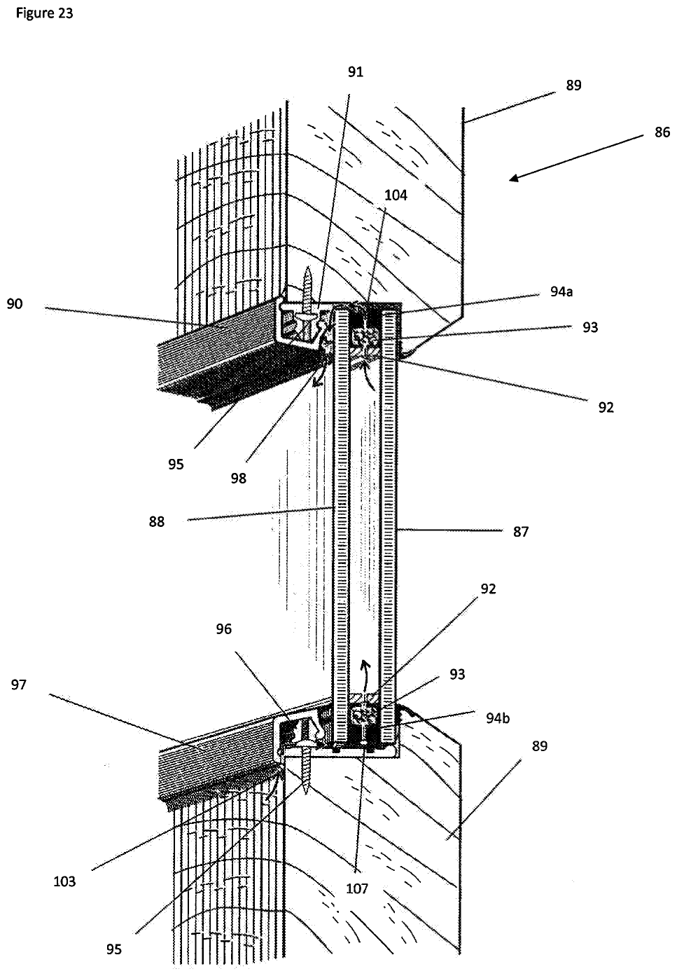

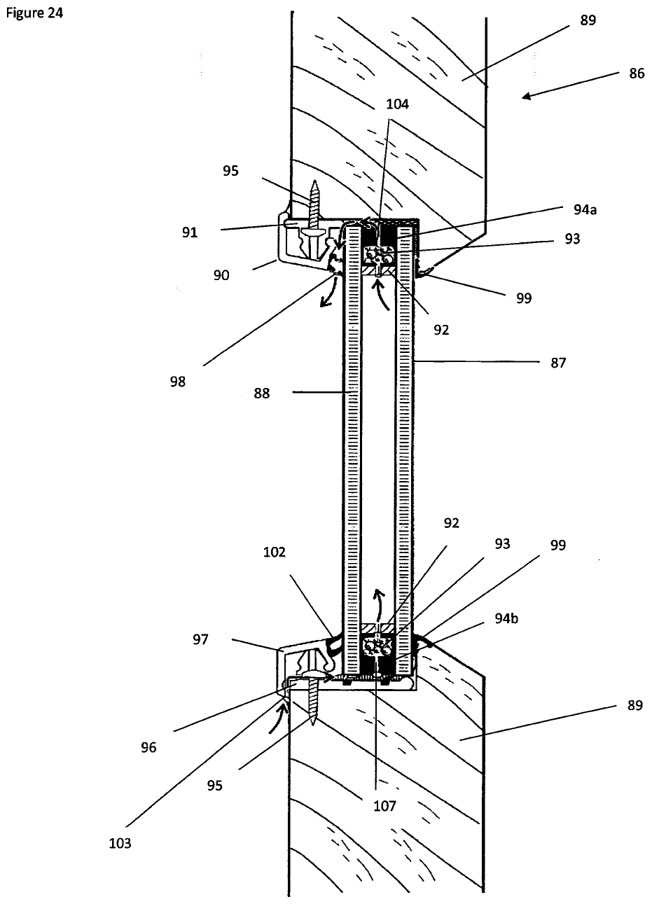

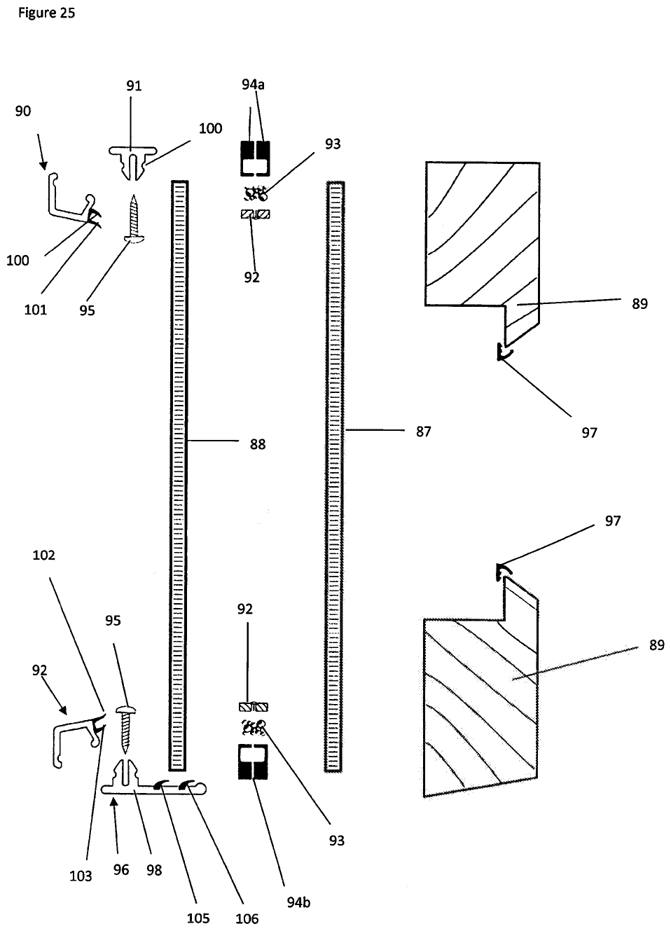

With reference to FIGS. 23 to 25 another embodiment of a double glazing unit 86 of the present invention is illustrated. This embodiment provides a standalone double glazing window. This embodiment utilises a combination of a wooden frame and PVCu profiling clips 90 (upper) and 97 (lower) to secure two glazing panels 87 and 88 within the rebated wooden frame 89. The PVCu extruded profiling cover clip 90 is secured to a complimentary shaped extrrib 91 that is fastened to the upper side of the wooden panel 89 through a fastener 95. As shown in FIGS. 24 and 25 the clip 90 is adapted to also provide sealing fins 100, 101 that are co-extruded with clip 90 from a more rubberised polymeric material. These fins are positioned against the glazing panel 88. The fins are also configured to include an orifice through which air from the cavity between the glass panels 88 and 87 can be vented. The PVCu extruded profiling cover clip 97 is secured to a complimentary shaped rib 96 that is fastened to the lower side of the wooden panel 89 through a fastener 95. As shown in FIGS. 24 and 25 the clip 97 is adapted to also provide sealing fins 102, 103 that are co-extruded with clip 92 from a more rubberised polymeric material. These fins are positioned against the glazing panel 88. The clip 97 is also configured to include an orifice through which air external of the glazing unit can be conveyed into the cavity between the glazing panels 88 and 87. The rib 96 over which the clip 97 engages is further adapted to provide an elongated base support on which the bottom edge of the glazing panels 87 and 88 are seated. Co-extruded polymeric fins 105 and 106 (best seen FIG. 25) are optionally provided on elongated base support 98 that effectively allows the glazing panels to float slightly above the base support 98 and to provide a softer seating option for the bottom edge of the glazing panels 87 and 88. The glazing panels 88 and 87 are spaced apart by wooden intermediate spacing units 92 (upper and lower) and polymeric spacing units 94a (upper) and 94b (lower). The desiccant housing and spacing units 94a and 94b are configured in shape to provide a housing space for a desiccant 93. The intermediate spacing units 92 and 94a and 94b together define a centrally located orifice through which air may be conveyed into the lower cavity between the glazing panels 87 and 88 or through which air may be conveyed out of the upper cavity between glazing panels 87 and 88. The air flow path is shown by arrows in FIGS. 23 and 24. An upper and lower sealing member 97 is provided between the edge of the wooden fame panel 89 and the glazing panel 87. This sealing member helps seat the glazing panel neatly against the frame of the wooden panel. In this embodiment the intermediate spacer 92 is prepared from wood so as not to detract from the aesthetics of the glazing unit. It is to be appreciated that a plastics or metal spacer could be used as alternative materials. The glazing unit 86 is vented. As illustrated in FIG. 23, a small orifice 104 is provided in the intermediate spacing unit 92 through which air can migrate from the cavity between the glazing panels 87 and 88, through the desiccant 93. The air that migrates into the space between the wooden frame 86 and the spacer 94a can migrate out of the glazing unit through a small orifice 98 in the bottom edge of the profile clip 90. In the lower portion of the glazing unit, the intermediate spacing unit 92, the desiccant 93 and the dessicant housing 94b are identical to what is used in the upper portion of the glazing unit. The arrangement of the spacing unit 92 and the desiccant housing 94b together define a small orifice 107 that extends from the base support 96 to the cavity between the glass panels 87 and 88. The extruded lower PVCu member 97 has similar features to the extruded upper cover PVCu member 90 except that a small orifice 103 is provided in the bottom edge of the PVC member 92 to allow the ingress of air external of the glazing unit to pass into the glazing unit. The double glazing unit 86 is an example of a vented double glazing system that allows air to flow around the glazing panels to manage the heating and cooling of the glazing unit under a range of temperature conditions without damaging the integrity of the glazing unit.

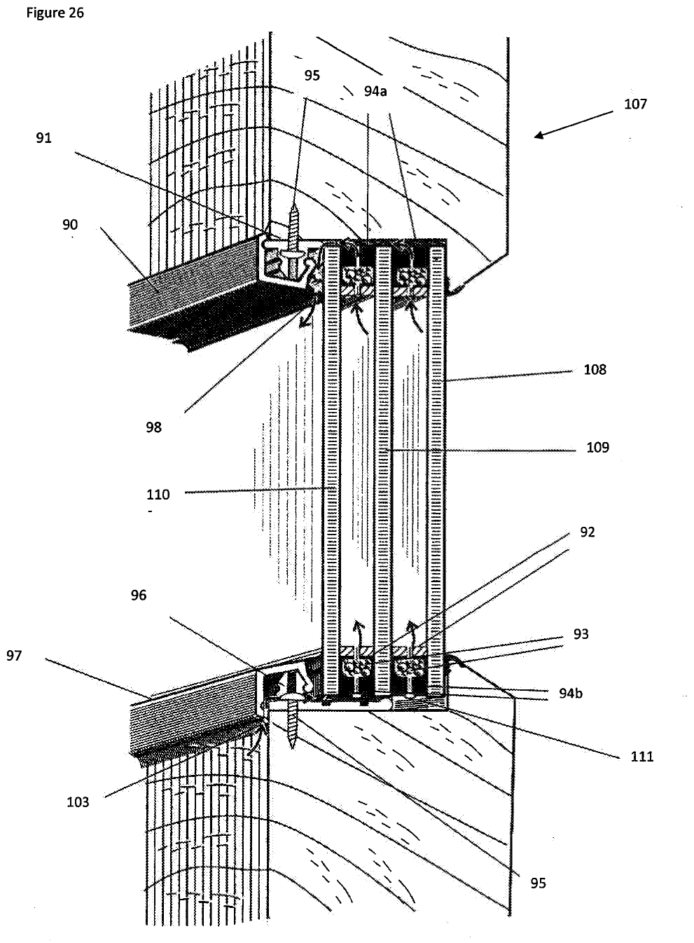

With reference to FIG. 26, a further embodiment of a standalone triple glazing window unit 107 of the present invention is illustrated. This embodiment is similar to the embodiment illustrated in FIGS. 23-25 with a further glazing panel 109 positioned intermediate glazing panels 108 and 110, the glazing panels being held within a wooden frame. The same profiled PVCu clips 90 and 97 from the embodiment shown in FIGS. 23-25 are suitable for use in the current embodiment. The intermediate spacers 92, the desiccant housing units 94a, 94b are equivalent to that used in the embodiment shown in FIGS. 23-25. The intermediate spacers are modified with intermediate slots 109 to receive the intermediate glazing panel 105 and to provide an orifice 110, 111 on either side of the glazing panel 105 whilst still containing the desiccant 112 that is housed between the intermediate spacer 108 and the PVCu clip 90. PVCu profile covers 113 and 114 act to interlock with the PVCu clip 90 to hold in place the glazing panels and to seal around the perimeter of the glazing unit. The PVCu profile covers 113 and 114 are identical to profile covers 91 and 102 described above for the embodiment illustrated in FIGS. 23-25. The triple glazing unit 104 is an example of a vented triple glazing system that allows air to flow around the glazing panels to manage the heating and cooling of the glazing unit under a range of temperature conditions without damaging the integrity of the glazing unit.

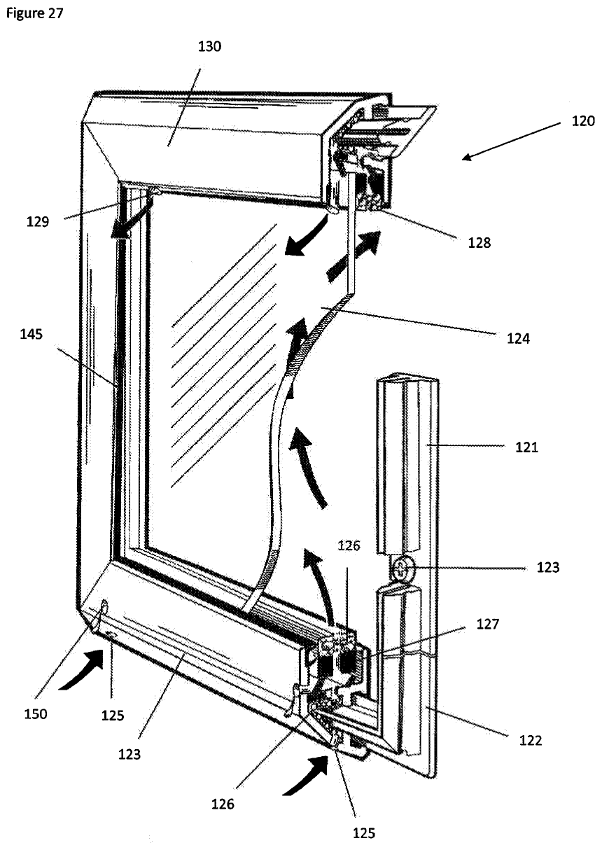

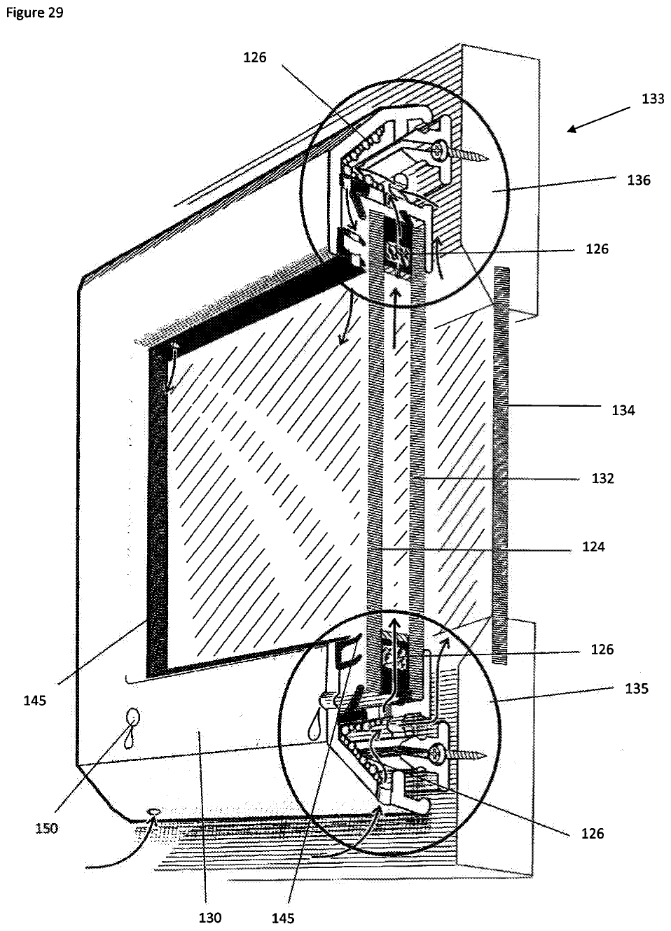

FIG. 27 shows a perspective view of another embodiment of a glazing unit 120 with a cut away section of the present invention. This embodiment of glazing unit 120 is framed with an unplasticised polyvinyl chloride (PVCu) cover 130. It is to be appreciated that other polymeric materials may be suitable for producing the covers or framing for the glazing unit. The cut away section reveals a further PVCu framework showing components 121, 122 that are used to affix the glazing unit 120 to an existing window (not shown) through a fastener means 123. The PVCu cover 130 clips over and onto the components 121 and 122 to secure the glazing unit 120 to the components 121 and 122. Similar components 121/122 extend around the periphery of the glazing panel 124 and the PVCu cover 130 also extends around the periphery of the glazing panel. The glazing unit 120 also provides a vented glazing system. FIG. 27 shows the air flow pathway entering in through the bottom vent/orifice 125 and progressing up through a cavity holding a desiccant 126 and then up through a vented spacer assembly 127 that holds further desiccant 126 into the space between the glazing panel 124 and the glass panel of an existing window (not shown). The thermal pumping process of the sun, or heat from the home, heating the air within the cavity, when the glazing unit is installed and in use, moves the air out through the upper vented spacer assembly 128, which includes more desiccant and out through orifices 129 in the PVCu cover 130. The heating air will carry with it any water vapour that rises as a result of the temperature increase experienced within the cavity between the glazing panels. A co-extruded PVC sealing rib 145 is integrated into the PVCu cover 130 that provides a rubberised seal between the rigid PVCu cover and the glazing panel 124. If any moisture enters behind the sealing rib 145 and runs down the glazing panel behind the PVCu cover, drainage hole 150 is provided in the cover to allow the release of such moisture. This is also well illustrated in FIG. 29.

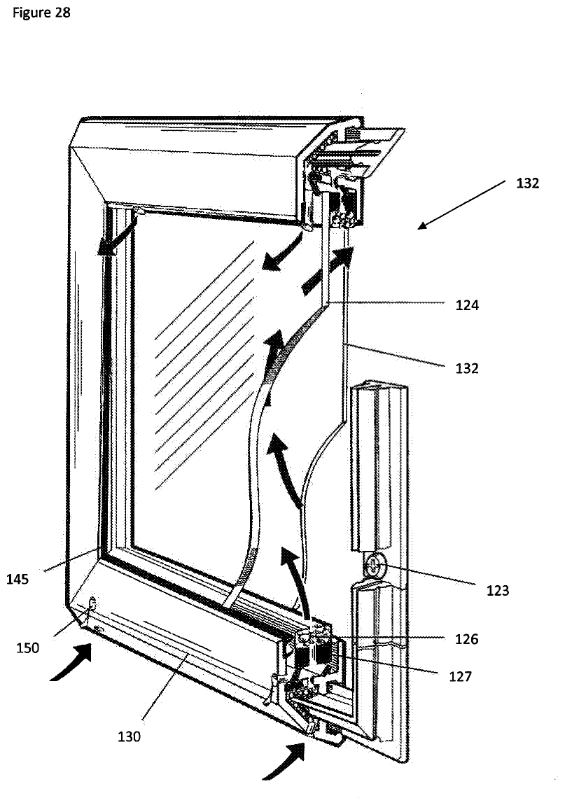

FIG. 28 is a perspective view with a cut away section of another embodiment of a glazing unit 131 of the present invention constructed as a PVCu framed, double glazing unit. This embodiment can also be used to provide a tertiary glazing system if it is applied to an existing single glazed window. Such a tertiary glazing system is best illustrated in FIG. 29-31. All features of the embodiment shown in FIG. 28 are identical to the features shown in FIG. 27, except for the fact that a second glazing panel 132 is included in this embodiment. The airflow movement within a glazing unit of this embodiment is shown in arrows where air can enter from the bottom of the glazing unit, and as it heats up within the glazing cavity will move up the glazing unit to be expelled out the top of the glazing unit.

It is to be appreciated that material used for each glazing panel in this embodiment may vary between the panels. For example one panel may be made from glass and the other panel from an acrylic glass (eg Plexiglas™) or the like.

FIG. 29 is a perspective view of the glazing unit embodiment shown in FIGS. 27 and 28 attached to an existing window 133 creating effectively a triple glazed window. This embodiment shows the existing window glass panel 134 and the new glazing panels 124 and 132. This view shows the key components including the upper and lower vent assemblies 135 and 136 depicted in the circled areas, each including two sources of a desiccating agent 126 within the vent assemblies respectively. As any water vapour flows through the vent assemblies 135 and 136, the clay will absorb the moisture from the air in the colder times and release water vapour in the warmer times. The heating and cooling is achieved through external events such as sunshine or home heating, and its counterpart of cooling over night. The intermediate glazing panel 132 may be made from an acrylic glass (eg Plexiglas™) or other such glazing panel. The glazing panel 132 directs any internal water vapour escaping between the existing window panel 134 and the glazing panel 132 upwardly toward the vent assembly 136 at the top of the glazing panels, which prevents the moisture meeting and condensing on the cold external glass panel 124. The flow of externally sourced air through the lower vent assembly 135 then between the glazing panels 124, 132 and 134 through the upper vent assembly 136 is schematically shown in FIG. 29 by the arrows.

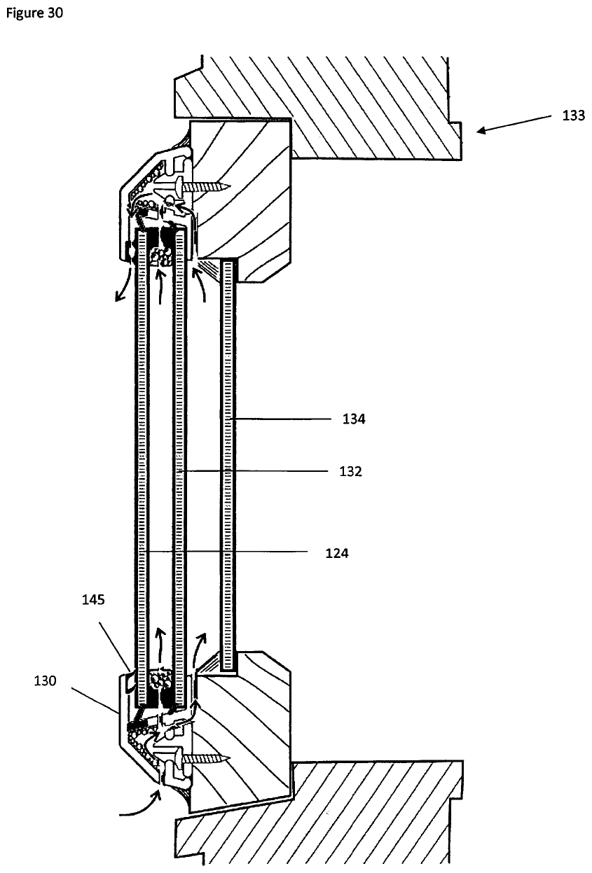

FIG. 30 is a cross section view of the present invention in relation to the embodiment shown in FIGS. 28 and 29. This cross-sectional view also shows the air flow paths using arrows through the lower and upper vent assemblies and between the glazing panels 132, 134 and 124.

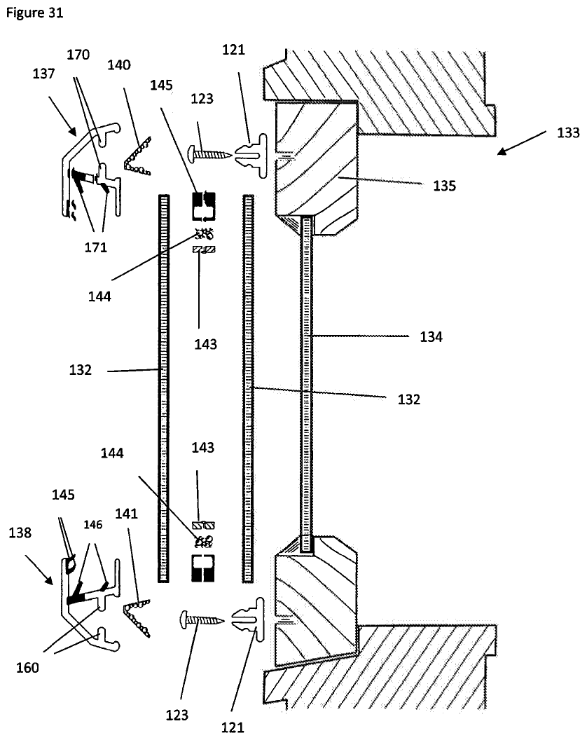

FIG. 31 is an exploded section view of the glazing unit shown in FIGS. 28 to 30. The exploded section view of the PVCu cover or outer frame profiles 137 and 138 (both shown in FIGS. 27 and 28 as frame cover 130) in relation to the existing window 133 are shown. This embodiment shows the existing glass panel 134 and the glazing panels 124 and 132. The exploded section view shows the key components required to assemble a glazing unit of the embodiment shown in FIGS. 28 to 30. In the first instance, affixing component 121 is fastened to the external wooden frame 135 around the periphery of the existing window using fasteners 123. The desiccant retaining member 141 is located within the PVCu frame cover 138 and then this cover is clipped over and engaged with component 121. The engagement is a physical engagement between the pair of lugs 160 on the frame cover 138 slotting into complimentary notches on component 121. The glazing panels are mounted onto the frame cover 138 and the panels are seated on fins or ribs 146. A PVC spacer 145, that houses an amount of a desiccant 144 and on top of which is placed a wooden spacer 143. It is to be appreciated that the wooden spacer 143 is provided primarily for aesthetic reasons. Similarly, the same components are assembled for the top of the glazing unit, except PVCu cover 137, which is similar to the lower cover 138, but which is shaped and configured to be used as the top cover is clipped over affixing component 121, where lugs 170 clip over and physically engage with complimentary notches on affixing component 121. The top edge of the glazing panels are butted against PVC fins or ribs 171 on the frame cover 138. The top PVCu cover 137 is also configured to include spaced apart orifices that allow heated air to escape from the top of the glazing unit. The PVC fins or sealing ribs of covers 137 and 138 are co-extruded with the rest of the PVCu profiles, and the sealing ribs are extruded from a more rubbery polymeric material than PVCu, such as PVC.

### Advantages and Industrial Applicability

It is one advantage of the invention to provide a glazing system or a glazing unit to prevent external water from being drawn into the window cavity. Surface water is directed away from the vent entries of the glazing system or glazing unit by use of drip edges and drainage channels.

It is another advantage of the invention to provide a glazing system or a glazing unit to prevent external moisture vapour from being drawn into the window cavity. The moisture vapour is captured by passing over a metal, clay, or desiccant material that absorbs the vapour before entering into the window cavity.

It is another advantage of invention to provide a glazing system or a glazing unit to enable water vapour within the window cavity to be vented out during its warm or hot cycle whereby moisture is expelled through higher humidity levels out the upper vents. It is another advantage of the invention to provide a device and a method of the kind referred to, prevent insects and dust to gain access into the cavity.

It is yet another advantage of the invention to provide an assembly of the kind referred to which will extend the service life of the glazed units.

It is yet another advantage of the invention to provide a glazing system of the embodiments described which will enable a simple manufacturing and installation process.

It is clear from the specification and the advantages noted that the invention has applicability in the glazing industry. Particularly applicability in the provision of a glazing system or a glazing unit to externally fit onto existing single glazed windows and doors. The primary function of the glazing system is to provide secondary glazing that can filter the moisture from external air as it flows into its cavity. The secondary function of the glazing system is to expel any moisture that may have entered the cavity between the glass panels. This dual functioning works to maximise the thermal efficiency of the resulting double-glazed panel by maintaining minimal air movement and maintaining dryness. The method of manufacture requires that two or four vents are used in opposite sides with one or two at the top most corner and the others positioned at the bottom most opposite corner(s). The heating of the sun or internal house temperatures will draw air through the lower vent(s) and expel the warm air out through the upper vent(s). The moisture as it warms will rise in the form of humidity and the thermal pumping action will expel the humid air out through the upper vent.

### Other Embodiments

While timber frames are preferred for their insulation qualities and ease of manufacturing, these materials could also be plastics or metals, which would necessitate different clasping mechanisms, fixing processes and sealing systems. These other various embodiments would still require the same scope of requirements to facilitate the external venting and preventing moisture ingress. Further variations of form and details may be required to accommodate different window shapes and designs which would still follow the same principles.

The present invention and its embodiments have been described in detail. However, the scope of the present invention is not intended to be limited to the particular embodiments of the invention described in the specification. Various modifications, substitutions, and variations can be made to the disclosed material without departing from the spirit and/or essential characteristics of the present invention. Accordingly, one of ordinary skill in the art will readily appreciate from the disclosure that later modifications, substitutions, and/or variations performing substantially the same function or achieving substantially the same result as embodiments described herein may be utilized according to such related embodiments of the present invention. Thus, the following claims are intended to encompass within their scope modifications, substitutions, and variations to the embodiments of the invention disclosed herein.

What is claimed is:

1. A glazing system comprising:
(i) a glazing frame;
(ii) at least one glazing panel set within the glazing frame so that the glazing frame surrounds the periphery of the glazing panel; and
(iii) the glazing frame further including at least one vent assembly positioned proximate the upper periphery of the glazing panel and at least one vent assembly positioned proximate the lower periphery of the glazing panel, the glazing frame and the glazing panel being configured to be attached to the external framework of an existing glazed unit to thereby provide a vented cavity between the glazing panel and the existing glazed unit, the at least one upper vent assembly providing a channel for air to move from the cavity between the glazing panel and the existing glazed unit to the exterior of the glazing system, and the at least one lower vented assembly providing a channel for air to move from the exterior of the glazing system into the interior space between the glazing panel and the existing glazed unit.

2. A glazing system as claimed in claim 1 including at least two glazing panels spaced apart within the glazing frame.

3. A glazing system comprising:
(i) a glazing frame;
(ii) at least two spaced apart glazing panels set within the glazing frame so that the glazing frame surrounds the periphery of the glazing panels; and
(iii) the glazing frame further including at least one vent assembly positioned proximate the upper periphery of the glazing panel and at least one vent assembly positioned proximate the lower periphery of the glazing panels to provide a vented cavity between the glazing panels, the at least one upper vent assembly providing a channel for air to move from the cavity between the glazing panels to the exterior of the glazing system, and the at least one lower vented assembly providing a channel for air to move from the exterior of the glazing system into the cavity between the glazing panels.

4. The glazing system as claimed in claim 1 wherein each vent assembly is positioned proximate a corner of the glazing frame.

5. The glazing system as claimed in claim 4 wherein each vent assembly is integrated into a corner component of the glazing frame, the corner component being configured to secure the glazing frame work extending from the corner in two substantially orthogonal directions, and the vent assembly being positioned between the substantially orthogonally extending frame work.

6. The glazing system as claimed in claim 1 wherein each vent assembly includes a vent chamber that is configured to provide an air channel from the interior of the glazing system to exterior of the glazing system.

7. The glazing system as claimed in claim 6 wherein each vent chamber is configured to prevent the ingress of water or moisture from the exterior of the glazing system into the vented cavity between the one or more glazing panels.

8. The glazing system as claimed in claim 6 wherein the one or more vent chambers house an amount of a desiccant, preferably selected from one of a bentonite clay, a synthetic desiccant and metal balls.

9. (canceled)

10. (canceled)

11. The glazing system as claimed in claim 1, wherein three spaced apart glazing panels are set within the glazing frame providing a triple-glazing system.

12. The glazing system as claimed in claim 11, wherein the glazing frame is constructed from wood, a polymeric material or a combination thereof.

13. The glazing system as claimed in claim 1, wherein the glazing frame is constructed from a polymeric material.

14. The glazing system as claimed in claim 13 wherein the polymeric material is a polyvinylchloride (PVC) material.

15. (canceled)

16. (canceled)

17. (canceled)

18. (canceled)

19. (canceled)

20. (canceled)

21. A vented multipaneled glazing unit comprising at least two spaced apart glazing panels, a peripheral frame securing the glazing panels at a distance from one another and enclosing a cavity between the glazing panels, the peripheral framework including at least one upper vented assembly that provides a channel for air to move from between the spaced apart glazing panels to the exterior of the glazing unit, and the peripheral framework including at least one lower vented assembly that provides a channel for air to move from the exterior of the glazing unit into the interior space between the spaced apart glazing panels.

22. The glazing unit as claimed in claim 21 wherein the upper and lower vented assemblies include a chamber to house a desiccant.

23. The glazing unit as claimed in claim 22 wherein the desiccant is selected from a bentonite clay, metal balls and a synthetic desiccant.

24. The glazing unit as claimed in claim 21 wherein the vented assemblies are configured in shape to prevent the ingress of water or moisture from the exterior of the glazing unit to the interior of the glazing unit.

25. The glazing unit as claimed in claim 21 wherein the peripheral frame is constructed from wood or a polymeric material or a combination thereof.

26. (canceled)

27. The glazing unit as claimed in claim 26, wherein the peripheral frame is constructed from wood and an extruded polymeric cover is used to secure the glazing panels along the length of the upper and lower peripheries of the frame.

28. The glazing unit as claimed in claim 27, wherein the extruded polymeric cover is further perforated to allow the passage of air into or out of the vented glazing cavity.

29. The glazing unit as claimed in claim 28 wherein the polymeric cover extends externally around the periphery of the glazing panels and the wooden frame to prevent the ingress of water or moisture into the vented glazing unit.
